(19) United States
(12) Patent Application Publication
(10) Pub. No.: US 2001/0036540 A1
(43) Pub. Date: Nov. 1, 2001

(54) Hinge covers

(76) Inventors: John Pringle, Woodside, NY (US); Hugh O'Donnell, Woodside, NY (US)

Correspondence Address: Matthew J. Peirce, Esq., 1550 Starlight Canyon Avenue, Las Vegas, NV, 89123, US

(21) Appl. No.: 09/828,387

(22) Filed: Apr. 5, 2001

Related U.S. Application Data
(60) Provisional application No. 60/195,423, filed on Apr. 10, 2000.

(51) Int. Cl. B32B 3/00

(52) U.S. Cl. 428/202

(57) ABSTRACT

A new and improved adhesive cover is disclosed that temporarily sticks to a door hinge or other hinge for protection while working, painting, or other related activities. The adhesive cover is designed to be an improvement over the traditional method currently used, which is to affix several pieces of masking tape over a door hinge until the entire hinge would be sufficiently covered. The adhesive cover is designed to be firmly affixed to a door hinge, while being capable of being easily removed by a user once the use of the present invention is no longer needed. The present invention is designed to increase protection and speed to make painting, varnishing, staining, or other similar activity easier and faster.

### I. BACKGROUND OF THE INVENTION

The present invention is that of a new and improved adhesive cover that temporarily sticks to a door hinge or other hinge for protection while working, painting, or other related activities.

### II. DESCRIPTION OF THE PRIOR ART

U.S. Pat. No. 5,722,120, issued to Bindschatel et al., discloses a pre-stamped half-hinge adherent cover designed to thoroughly protect all exposed surfaces of a half-hinge attached within the hinge recess of a door or jamb during the operation of coating.

U.S. Pat. No. 5,056,191, issued to Love, discloses a paint mask for a butt hinge and a masking method for protecting the hinge against paint spray or the like.

U.S. Pat. No. 4,796,330, issued to Ziegler, discloses a hinge mask product which consists of two substantially rectangular parts, with one of the parts having a tab for removal of this one part.

### III. SUMMARY OF THE INVENTION

The present invention is that of a new and improved adhesive cover that temporarily sticks to a door hinge or other hinge for protection while working, painting, or other related activities. The present invention is designed to be an improvement over the traditional method currently used, which is to affix several pieces of masking tape over a door hinge until the entire hinge would be sufficiently covered. The present invention is designed to be firmly affixed to a door hinge, while being capable of being easily removed by a user once the use of the present invention is no longer needed. The present invention is designed to increase protection and speed to make painting, varnishing, staining, or other similar activity easier and faster.

There has thus been outlined, rather broadly, the more important features of an adhesive cover for protecting hinges in order that the detailed description thereof that follows may be better understood and in order that the present contribution to the art may be better appreciated. There are, of course, additional features of the adhesive cover for protecting hinges that will be described hereinafter and which will form the subject matter of the claims appended hereto.

In this respect, before explaining at least one embodiment of the adhesive cover for protecting hinges in detail, it is to be understood that the adhesive cover for protecting hinges is not limited in its application to the details of construction and to the arrangements of the components set forth in the following description or illustrated in the drawings. The adhesive cover for protecting hinges is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present adhesive cover for protecting hinges. It is important, therefore, that the claims be regard as including such equivalent constructions insofar as they do not depart from the spirit and scope of the present invention.

It is therefore an object of the present invention to provide an adhesive cover for protecting hinges which has all of the advantages of the prior art and none of the disadvantages.

It is another object of the present invention to an adhesive cover for protecting hinges which may be easily and efficiently manufactured and marketed.

It is another object of the present invention to provide an adhesive cover for protecting hinges which is of durable and reliable construction.

It is yet another object of the present invention to an adhesive cover for protecting hinges which is economically affordable and available for purchase.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a front perspective view of a representative model of a typical door hinge.

FIG. 2 shows a front perspective view of a representative model of a typical door hinge substantially covered by the present invention.

FIG. 3 shows a perspective view of a plurality of the present invention attached to a roll.

### V. DESCRIPTION OF THE PREFERRED EMBODIMENT

Referring now to FIG. 1, a front perspective view of door hinge 2 can be seen. Door hinge 2 is meant to be a representative model of a typical door hinge and is by no means shown to indicate the only possible shape of a door hinge that could be used with the present invention.

Door hinge 2 has sections 4 and 6. Sections 4 and 6 each have two sides, an inner side and an outer side, with sections 4 and 6 each having a plurality of cylindrical tubes 5 attached to the entire length of their respective inner sides. Each tube 5 would be hollow. The series of tubes 5 on the inner side of section 4 and the series of tubes 5 on the inner side of section 6, when placed together, would be designed to form one single, uninterrupted long hollow tube. Once this occurs, a nail or rod 7 would be inserted through the long hollow tube to ensure that sections 4 and 6 would remain attached to one another.

Of sections 4 and 6, one of the sections would be fixedly mounted to the inner side of a door frame, while the remaining section of sections 4 and 6 would be fixedly attached to a door at the same height as the section fixedly mounted to the inner side of a door frame.

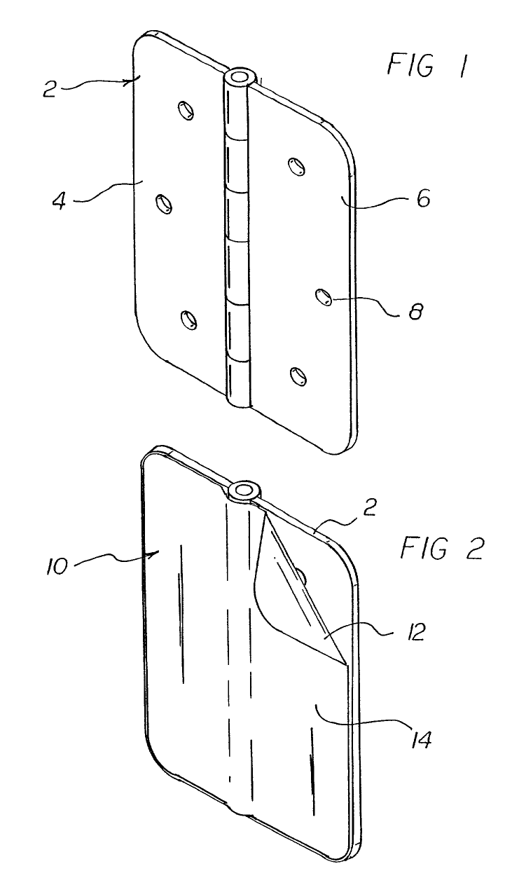

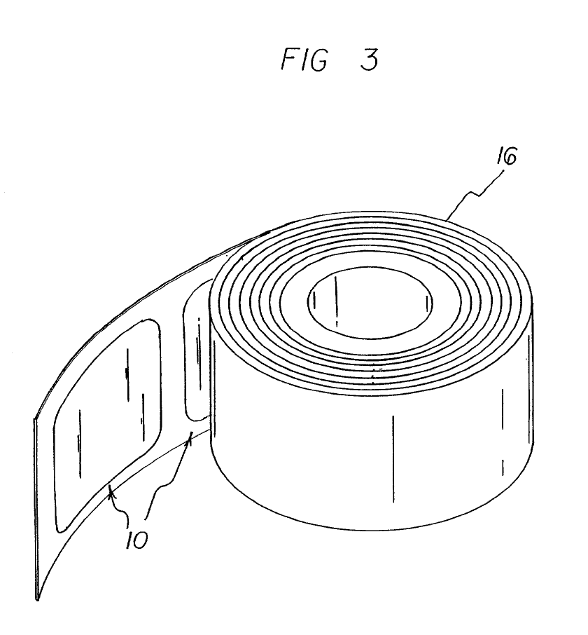

In FIG. 2, a front perspective view of door hinge 2 can be seen with hinge cover 10 firmly attached to the front face of door hinge 2. Hinge cover has two sides, an adhesive side 12 and a non-adhesive side 14. Hinge cover 10 is designed to be firmly affixed to a door hinge 2, while being capable of being easily removed by a user once the use of the hinge cover 10 is no longer needed. Hinge cover 10 would be available in a wide variety of sizes.

In FIG. 3, roll 16 is shown. A plurality of hinge covers 10 would preferably be purchased in a roll 16 similar or identical to the one portrayed in FIG. 3. Ideally, roll 16 would include twenty hinge covers 10, but roll 16 could be designed to include more or less hinge covers, depending on the need of a particular user, and also depending on whether the product would be purchased for residential, commercial, or industrial use.

What I claim as my invention is:

1. An adhesive cover for temporarily covering a door hinge, the adhesive cover having two sides, a first side and a second side, the first side having an adhesive substance uniformly applied to the first side.

2. An adhesive cover according to claim 1, wherein the adhesive substance uniformly applied to the first side would have sufficient strength and adhesive characteristics to hold the adhesive cover to a surface once the first side of the adhesive cover had been uniformly applied to the surface, the adhesive cover further having adhesive characteristics that would allow the first side of the adhesive cover to be uniformly pulled off a surface without tearing after the first side of the adhesive cover had been placed against the surface and left against the surface for a period of time.

3. An adhesive cover according to claim 1 in combination with a door hinge, the first side of the adhesive cover being applied to the door hinge and being contact with the door hinge.
